(19) United States
(12) Patent Application Publication
(10) Pub. No.: US 2004/0080319 A1
(43) Pub. Date: Apr. 29, 2004

(54) MIP microcantilever sensor and a method of using thereof

(76) Inventor: John H. Merrill, South Portland, ME (US)

Correspondence Address: Law Office of William B. Ritchie, 43 Jackson Street, Concord, NH, 03301, US

(21) Appl. No.: 10/690,728

(22) Filed: Oct. 23, 2003

Related U.S. Application Data
(63) Continuation of application No. 10/140,491, filed on May 7, 2002, now abandoned.

(51) Int. Cl. G01N 27/02

(52) U.S. Cl. 324/439

(57) ABSTRACT

A microcantilever sensor using molecular imprinting polymerization (MIP) technology, and a method of using thereof. The MIP microcantilever sensor is placed into a conduit, where it processes either an aqueous or environmental flow, or else a bodily fluid. The MIP microcantilever sensor provides for continuous on-line monitoring of the flow whereby the sensor monitors for any target analyte in which the MIP has been fabricated to attract. The present invention can be used to detect organic molecules, inorganic molecules, inorganic ions or viruses, pathogens, microorganisms, parasites or any other biological substance in which detection is desired. When the MIP microcantilever sensor detects the target analyte, the microcantilever sends a signal to a microprocessor for. In an alternate embodiment, a sensor array may be disposed in the conduit including a plurality of microcantilevers

### FIELD OF THE INVENTION

This invention relates to the field of molecular imprinted polymers (MIPS) and, in particular, to a molecular imprinted polymer microcantilever sensor and a method of using thereof.

### BACKGROUND OF THE INVENTION

Designing sensors for pollutants has long been, and still is, an important technological challenge. U.S. Pat. No. 5,990,684, issued to Merrill (the '684 patent), which patent is herein incorporated by reference in its entirety, is directed to a “method and apparatus for continuously monitoring an aqueous flow to detect and quantify ions.” The method involves providing a conduit having at least one ion collection portion, disposing the aqueous flow through the conduit, attracting target ions to the ion collection portion such that they are bonded to the ion collection portion, and detecting a contaminant, or contaminants, based upon a predetermined property of the plurality of target ions bonded to the ion collection portion. In the preferred embodiment of the method, the predetermined property is a conductivity of the target ions, and the detecting step involves measuring a change in conductivity of the collection portion as ions are bonded and comparing that conductivity to a predetermined conductivity. The apparatus includes a conduit into which an ion collection portion is disposed, a sensor that senses ions collected on the ion collection portion and sends a signal corresponding to a value of a predetermined property of the ions, and a microprocessor in communication with the sensor and programmed to process the signal and determine the presence of the at least one contaminant based upon the processed signal.

Microcantilever sensors, or microelectro mechanical sensors (MEMS) are well known in the art and are useful for detecting targeted chemicals or pollutants in a monitored atmosphere or solution. For example, U.S. Pat. No. 5,719,324 issued to Thundant, et al. discloses a microcantilever sensor attached to a piezoelectric transducer. The sensor is provided with a frequency detection means and a bending detection means to sense changes in the resonance frequency and the bending of a vibrated microcantilever. The extent of the changes is related to the concentration of target chemical within a monitored atmosphere. Although the '324 patent is useful for sensing a targeted chemical, there are many drawbacks to the apparatus. First, because the apparatus is only surface treated with a compound selective substance having substantially exclusive affinity for a targeted compound in a monitored atmosphere, the compound selective substance is vulnerable to harsh environments, i.e. extreme hot, or cold. Second, because the compound selective substance is applied as a film onto the microcantilever, the substance can be easily removed, and therefore, may wash off before the desired time. Finally, the compound selective substance is not a specialized, highly sensitive method of selecting targeted compounds, and therefore, may not sense small amounts of targeted compound. Thus, the apparatus disclosed in the '324 patent is not designed for reliable long-term, highly sensitive monitoring of a target compound.

More recently, a technique known as molecular imprinting has been used to detect target molecules of pollutants. Molecular imprinted polymers (MIPs) are a molecular technology that allows for the selective recognition of targeted molecules by cross-linked polymers. Though recent, the molecular imprinting technique is known in the art. For example, U.S. Pat. No. 5,630,978 discloses a method for preparing mimics of a wide variety of drugs and other biologically active molecules using molecular imprinting techniques. Additionally, U.S. Pat. No. 5,959,050 is directed to a molecularly imprinted support formed from at least two distinct acrylic monomers and at least one imprinted molecule.

Therefore, what is needed is a sensor device capable of long term reliable monitoring of target compounds in a variety of environments, where the recognition element is incapable of simply washing off, which employs the molecular imprinted polymer technology, which is capable of detecting very small quantities of target compound, that utilizes the microelectrical mechanical technology as a transducer, and is capable of sensing target molecules in fluid or atmosphere. A device that utilizes the advantages of both molecular imprinted polymer technology and the sensitivity of a microcantilever sensors is desired in the art.

### SUMMARY OF THE INVENTION

The present invention combines molecular imprinted polymers (MIP) molecular recognition technology, which allows for the selective recognition of targeted molecules by cross-linked polymers, with the sensitivity offered by microcantilever sensors. The MIP microcantilever sensor provides high sensitivity and fast sensing for small molecules. Continuous on-line monitoring of contaminants is thus possible in an aqueous flow, in open air, or even in bodily fluids for medical applications.

As disclosed in the incorporated '684 patent, an apparatus for the continuous monitoring of contaminants includes a conduit into which an ion collection portion is disposed, a sensor that senses ions collected on the ion collection portion and sends a signal corresponding to a predetermined property of the ions, and a microprocessor in communication with the sensor and programmed to process the signal and determine the presence of at least one contaminant based upon the processed signal. In the present invention, microcantilever sensors are used to detect the collected molecules and ions. Said molecules are attracted to the microcantilever sensors by MIPs fabricated to recognize the specific molecules. Although, the '684 patent specifically discloses the device's use in an aqueous flow, the present invention may also be used to monitor bodily fluids, atmospheres, or other environments likely to contain contaminants.

Therefore, it is an aspect of this invention to apply MIP molecular recognition technology to microcantilever sensors.

It is another aspect of the invention to provide continuous on-line monitoring for specified contaminants in a variety of environments.

It is a further aspect of the invention to provide a MIP microcantilever sensor that is efficient and sensitive to detecting specified pollutants.

These aspects of the invention are not meant to be exclusive and other features, aspects, and advantages of the present invention will be readily apparent to those of ordinary skill in the art when read in conjunction with the appended claims.

### BRIEF DESCRIPTION OF THE DRAWINGS

FIG. 1 is an isometric view of the microcantilever sensor having a molecular imprinted polymer layer deposited on the top electrode.

FIG. 2 is a schematic view of the molecular imprinted polymer cantilever sensor interacting with the target analytes.

FIG. 3 is a schematic view of the conduit.

### DETAILED DESCRIPTION OF THE INVENTION

Microcantilevers are useful for a variety of sensor applications, as they provide a simple means for developing single and multi-element sensors that are relatively inexpensive and highly sensitive. In fact, microcantilevers are produced that are sensitive enough to detect individual atoms. Additionally, they provide real time monitoring of chemical properties. Microcantilever sensors undergo a static bending or a change in resonant frequency in direct response to a mass of adsorbed molecules on the sensor surface. The resonance frequency, f, of an oscillating cantilever can be expressed as:

f=(1/2π)(K/m)

where K is the spring constant of the cantilever and m is the effective mass.

The resonance frequency of a microcantilever sensor can change in response to changes in the effective mass as well as changes in the spring constant. Cantilevers with localized adsorption areas at the terminal end of the cantilever minimize differential surface stress, thereby minimizing the effects of a change in the spring constant. As such, is changes in the resonance frequency can be attributed solely to changes in the mass.

In the present invention, rather than relying on molecules adsorbing on the surface of the microcantilever sensor, molecular imprinting polymerization (MIP) is used as the recognition element of the sensor. Cross-linked polymers form a matrix that is coated on the surface of the microcantilever sensor. The MIPs are fabricated to selectively recognize targeted molecules, thereby allowing the microcantilever to detect the presence of certain contaminants in the environment by bending in response to the change in mass when the target contaminant molecule binds with the MIP.

Molecular imprinting is the technique of co-polymerizing functional and crosslinking synthetic monomers. This is done in the presence of a target molecule, which is the imprint molecule. When polymerized, the functional groups are held in position by the highly cross-linked polymeric structure. The imprint molecule is then removed, revealing binding sites to attract the target molecules. The MIP has a highly specific molecular memory, and is capable of binding with the selected target molecule.

Turning now to the incorporated '684 patent, a monitor apparatus and method is disclosed for detecting and quantifying specified ions. While the '684 patent describes the use of the apparatus in an aqueous flow, the present invention may conceivably be used in a variety of environments, including in the atmosphere or in bodily fluids to detect whatever contaminants the MIPs are fabricated to recognize. Because MIP techniques are more stable and robust with their highly cross-linked polymetric structure than, for example, real antibodies currently used in sensor technology, MIPS may be used in harsher environments, such as bodily fluids. However, regardless of the environment, the basic monitor remains the same.

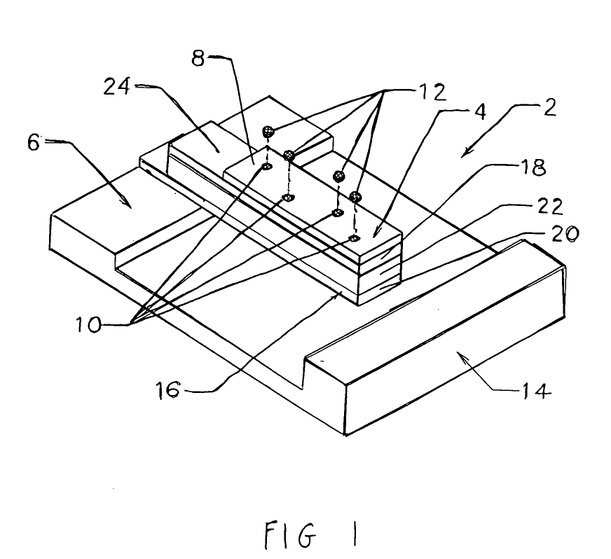

Referring first to FIG. 1, the preferred embodiment of the MIP microcantilever sensor 2 (hereafter referred to as MEMS/MIPS sensor) is shown. The MEMS/MIPS sensor 2 has a MIP receptor 4 and a transducer 6. The MIP receptor 4 consists of a layer of a molecular imprinted polymer (MIP) 8 having molecular recognition sites 10 that attract and are selective for target analytes 12. The target analytes 12 may consist of organic molecules, inorganic molecules, inorganic ions or viruses, pathogens, microorganisms, parasites or any other biological substance in which detection is desired.

The tranducer 6 has a base 14 and a microcantilever platform 16. The microcantilever platform 16 consists of an upper electrode 18, a lower electrode 20 and a piezoelectric layer 22. The lower electrode 20 is affixed to the base 14. The piezoelectric layer 22 can be a plate made of quartz, or of any other piezoelectric material commonly used in the art.

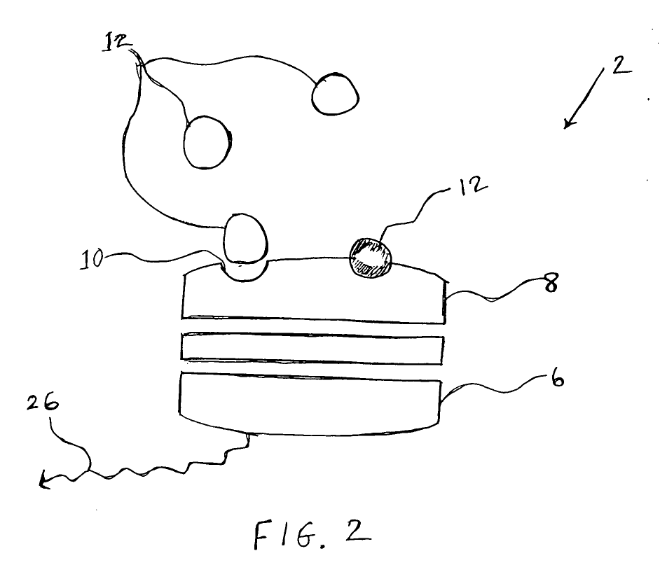

Referring next to FIG. 2, a schematic view of the MEMS/MIP sensor 2 is shown in practice to demonstrate the interaction between the MIP layer 10 and the target analyte 12. The tranducer 6, which includes the microcantilever platform, is depicted. The MEMS/MIP sensor 2 can recognize the contaminant or target analyte 12 attracted by the MIP 8. As the MIP 8 attracts the target analytes 12, the effective mass of the microcantilever changes, causing a deflection in the cantilever which generates a voltage across the electrodes (not shown) due to the piezoelectric effect. In response to the change in the voltage across the electrodes, the microcantilever sensor 2 can send a signal 26 indicating the targeted contaminant or analyte 12 is present in the environment.

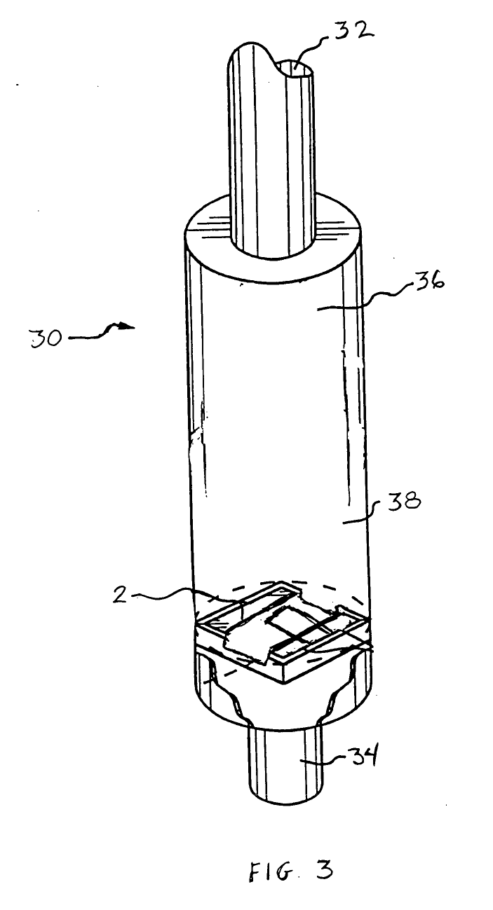

Referring back to FIG. 1, the MIP 8 is affixed onto the MIP receptor 4, which is affixed to a top surface 24 of the upper electrode 18. Additionally, although the MEMS/MIPS sensor 2 is depicted independent of a conduit, the MEMS/MIPS sensor 2 includes a conduit (shown in FIG. 3). Referring next to FIG. 3, the conduit 30 that holds the MEMS/MIPS sensor 2 is shown. Although the '684 patent, described above, discloses an ion exchange resin disposed within the conduit 30 to detect contaminants, the present invention instead disposes a MEMS/MIPS sensor 2 within the conduit 30. The MEMS/MIPS sensor 2 includes a terminal end onto which is coated a MIP. As the MIP has a molecular memory fabricated to recognize a specified contaminant, there is no need to include a doped ion exchange resin. A suitable microcantilever must be disposed in the conduit, i.e., one that can operate in the environment into which the conduit is placed and one sensitive enough to detect a change in mass when the MIP attracts a target molecule.

In practice, the MEMS/MIPS sensor operates as follows. The conduit 30 has an inlet 32, in which the fluid or atmosphere to be monitored enters. The fluid or atmosphere then flows through the top region 36 and into the bottom region 38. The fluid or atmosphere then encounters the MEMS/MIPS sensor 2. If the fluid or atmosphere contains the target analyte, then the MEMS/MIPS sensor will emit a signal, as depicted in FIG. 2. The fluid or atmosphere then flows out of the conduit 30 via the outlet 34.

In the preferred embodiment of the invention, a microprocessor is included to process the signal sent from the microcantilever sensor. The microprocessor can determine from the processed signal what contaminant is present and in approximately what amounts. The information is based on the specific targeted molecule the MIP was fabricated to attract and the change in the voltage across the electrodes of the microcantilever sensor.

In an alternate embodiment, a sensor array may be disposed in the conduit including a plurality of microcantilevers. The number of different target contaminants a monitor can detect is limited only by the MIPs included on the microcantilever sensor array. A variety of MIPS fabricated to attract different targeted molecules may be included in the matrix coated onto the terminal end of the sensor. As such, a single monitor can detect a variety of contaminants in an environment. Similarly, different sensor arrays may be disposed in the conduit with each array having MIPS with a fabricated molecular memory to attract a different contaminant. As such, a monitor may try to detect more than one contaminant at a time, and the processed signal sent to the microprocessor can determine which targeted contaminant has been detected.

In a second alternative embodiment, a plurality of MIPs (detecting a plurality of targets) may be disproved on a single MEMs device. Therefore, a single MIPs/MEMS can detect a family of targets. This embodiment can then become a series of multi-targeted sensors on a plurality of microcantilevers.

Although the present invention has been described with reference to certain preferred embodiments thereof, other versions are readily apparent to those of ordinary skill in the art. Therefore, the spirit and scope of the appended claims should not be limited to the description of the preferred embodiments contained herein.

What is claimed is:

1. An apparatus for detecting contaminants, said apparatus comprising:
a conduit;
a microcantilever sensor disposed within said conduit and having a surface; and
a molecular imprinted polymer to attract said contaminant, said polymer being coated on said surface of said microcantilever sensor;
wherein said microcantilever sensor sends a signal indicating said polymer has attracted said contaminant.

2. The apparatus as claimed in claim 1, wherein said microcantilever sensor further comprises a terminal end, and wherein said surface is disposed on said terminal end.

3. The apparatus as claimed in claim 1, wherein said microcantilever sensor is one of a plurality of substantially identical microcantilever sensors, and wherein said plurality of microcantilever sensors comprise a sensor array disposed in said conduit.

4. The apparatus as claimed in claim 3 further comprising a microprocessor in communication with said sensor array, said microprocessor being programmed to process said signal and determine the presence of said contaminant based upon the processed signal.

5. The apparatus as claimed in claim 3 further comprising a second sensor array, and wherein said second sensor array is fabricated to attract a separate contaminant than said sensor array.

6. The apparatus as claimed in claim 5 further comprising a microprocessor in communication with said sensor array and said second sensor array, said microprocessor being programmed to process said signal and determine the presence of at least one contaminant detected by said sensor array or said second sensor array based on said processed signal.

7. A sensor for detecting the presence of at least one contaminant using molecular imprinted polymers, said sensor comprising:
a microcantilever sensor having a surface; and
a matrix of synthesized polymers coating said surface;
wherein said matrix forms a molecular imprinted polymer fabricated to attract a specific contaminant, and wherein said microcantilever sensor detects the presence of said contaminant attracted to said matrix.

8. The sensor as claimed in claim 7, wherein said microcantilever is one of a plurality of substantially identical microcantilever sensors, and wherein said plurality of microcantilever sensors form a sensor array.

9. A method for detecting at least one contaminant comprising the steps of:
providing a conduit having a microcantilever sensor;
disposing said conduit in an environment to be monitored;
coating a surface of said microcantilever sensor with a molecular imprinted polymer matrix;
attracting a plurality of target molecules to said matrix such that said plurality of molecules is bonded to the molecular imprinted polymer; and
detecting at least one contaminant base on said microcantilever sensor's reaction to said molecules bonded to said polymer;
wherein a specified contaminant is detected in said environment.

10. The method as claimed in claim 9, wherein said environment is selected from the group consisting of an aqueous flow, an atmosphere, and a bodily fluid.

11. The method as claimed in claim 9 further comprising the step of depositing said microcantilever sensor in a sensor array, said sensor array comprising a plurality of substantially identical microcantilever sensors.

12. The method as claimed in claim 11 further comprising the step of including a second sensor array, said second sensor array comprising a plurality of microcantilever sensors fabricated to recognize a second contaminant.

13. The method as claimed in claim 12 further comprising the steps of processing a signal from said sensor array and said second sensor array and determining which contaminant has been detected based on said signal.
